(19) United States
(12) Patent Application Publication
(10) Pub. No.: US 2009/0111012 A1
(43) Pub. Date: Apr. 30, 2009

(54) SECONDARY BATTERY

(75) Inventors: Mashio Shibuya, Fukushima (JP); Masaki Machida, Fukushima (JP)

Correspondence Address: BELL, BOYD & LLOYD, LLP, P. O. BOX 1135, CHICAGO, IL, 60690, US

(73) Assignee: Sony Corporation, Tokyo (JP)

(21) Appl. No.: 12/243,630

(22) Filed: Oct. 1, 2008

(30) Foreign Application Priority Data
Oct. 31, 2007 (JP) 2007-284109
Feb. 19, 2008 (JP) 2008-037712

(51) Int. Cl. H01M 2/02

(52) U.S. Cl. 429/163

(57) ABSTRACT

A secondary battery incoludes a positive electrode, a negative electrode including an anode active material layer formed on at least one side of a negative electrode current collector, an electrolyte, and a laminate-film casing member containing therein the positive electrode, the negative electrode, and the electrolyte. The electrolyte contains a non-aqueous solvent which includes a cyclic carbonic ester in an amount of 80 to 100%, based on a total weight of the non-aqueous solvent. The also contains an electrolyte salt in a concentration of 0.8 to 1.8 mol/kg. The anode active material layer contains a polymer which includes repeating units derived from vinylidene fluoride. A peel strength between the anode active material layer and negative electrode current collector is 4 mN/mm or more as measured after immersing the anode active material layer into a solvent.

### CROSS-REFERENCE TO RELATED APPLICATIONS

The present application claims benefit of priority of Japanese patent Applications No. 2008-284109 filed in the Japanese Patent Office on Oct. 31, 2007, and No. 2008-37712 filed in the Japanese Patent Office on Feb. 19, 2008, the entire disclosures of which are incorporated herein by reference.

### BACKGROUND

The present application relates to a secondary battery covered with a laminate film. More particularly, the present application relates to a secondary battery which is capable of maintaining a high battery capacity and an excellent cycle characteristic even when used and/or produced under conditions such that the battery is subjected to an environment at a high temperature.

In recent years, various types of portable electronic devices, such as camera-integrated videotape recorders (VTRs), cellular phones, and laptop computers, are widely used, and those having smaller size and weight are being developed. As the portable electronic devices are miniaturized, demand for battery as a power source of them is rapidly increasing, and, for reducing the size and weight of the device, a battery for the device needs to be designed so that the battery is lightweight and thin and efficiently uses the space in the device. As a battery that meets such demands, a lithium-ion secondary battery having a large energy density and a large power density is the most preferable.

Specifically, a lithium-ion secondary battery using a laminate film as a casing member is widely used. Such a lithium-ion secondary battery is produced by, for example, as described in patent documents 1 and 2 identified below, a separator is disposed between a strip positive electrode and a strip negative electrode each having an electrode terminal connected thereto and they are stacked on one another, and then spirally wound together in the longitudinal direction to prepare a battery element. Then, the resultant battery element is covered with a laminate film and then the film is sealed to produce a secondary battery. The secondary battery is connected to a circuit board having a protection circuit formed thereon, and contained in, for example, a resin molded casing or a rigid laminate film to form a battery pack. When a laminate film is used as a casing member, there can be produced a lightweight battery having a reduced thickness and an increased area, which is difficult to achieve when a metallic can is used as a casing.

[Patent document 1] Japanese Unexamined Patent Application Publication No. 2002-8606

[Patent document 2] Japanese Unexamined Patent Application Publication No. 2005-166650

A polymer battery using a gel electrolyte has been put into practical use, wherein the gel electrolyte is obtained by gelling an electrolytic solution with a polymer (matrix polymer) and fixed to the surface of each of the positive electrode and the negative electrode. With respect to the matrix polymer, polyvinylidene fluoride (PVdF), polyacrylonitrile (PAN), polyethylene oxide (PEO), or the like is used. The polymer battery is free of leakage of electrolytic solution and hence achieves very high reliability.

In the battery using a laminate film as a casing member, the outer shape of the battery easily deforms when gas is generated inside the battery. Accordingly, a cyclic carbonic ester having a higher boiling point is included in a high concentration into the non-aqueous solvent for electrolyte to suppress gas generation in the battery. A cyclic carbonic ester has a high permittivity as compared to a chain carbonic ester, thereby having a high electric conductivity. As a result, the use of a cyclic carbonic ester can reduce relatively a mixing amount of the electrolyte salt.

### SUMMARY

However, in the above-mentioned secondary battery, when the cathode active material layer and anode active material layer are increased in thickness to improve the capacity and volumetric efficiency of the battery, a drawback occurs in that a region in which a battery reaction hardly proceeds appears in part of the active material layer. This drawback may be solved by increasing the concentration of the electrolyte salt in the electrolyte, but the increased electrolyte salt concentration causes the adhesion between the current collector and the active material layer under a high temperature environment to be poor, and another drawback may occur in that the active material layer is peeled off or flaked off. Peel-off or flake-off of the active material layer leads to lowering of the battery capacity or cycle characteristics. The peel-off or flake-off of the active material layer is caused due to swelling of the binder contained in the active material layer under a high temperature environment, and the use of a cyclic carbonic ester having a high permittivity in the non-aqueous solvent further promotes swelling of the binder.

In the production of polymer battery, there is a heating step for forming a gel electrolyte. This step is performed for dissolving the polymer, crosslinking the gel electrolyte, or applying a gel electrolyte precursor in a molten state at a high temperature to the surface of the electrode. In this step, the active material layer and electrolyte are heated in a state such that they coexist, and therefore, the binder contained in the active material layer possibly swells with the non-aqueous solvent, so that the active material layer is flaked-off from the current collector, whereby there may be a case in which the battery production itself is difficult.

The above drawback may be solved by increasing the amount of the binder contained in the active material layer; however, the increased amount of the binder which does not contribute to a battery reaction, in the anode active material layer causes the battery capacity to lower. Thus, this method is not preferable.

A reduction in adhesion between the active material layer and the current collector is disadvantageous from the viewpoint of reliability of the battery. For example, when the anode active material layer is flaked off from the negative electrode current collector to expose the negative electrode current collector, there is a possibility that short-circuiting occurs between the negative electrode current collector and the opposite positive electrode current collector to cause heat generation. When the heating is so great that the battery causes abnormal heating, fluorine contained in a binder including vinylidene fluoride, such as polyvinylidene fluoride, in the negative electrode and lithium occluded in the negative electrode undergo an exothermic reaction, so that the battery temperature further rises, which may lead to decomposition of the binder.

Accordingly, it is desirable to provide a secondary battery which maintains a high battery capacity and an excellent cycle characteristic and surely achieve safety even when used or produced under conditions such that the battery is subjected to an environment at a high temperature.

In accordance with one embodiment, there is provided a secondary battery which includes a positive electrode, a negative electrode including an anode active material layer formed on at least one side of an negative electrode current collector, an electrolyte, and a laminate-film casing member containing therein the positive electrode, the negative electrode, and the electrolyte. The electrolyte contains a non-aqueous solvent which includes a cyclic carbonic ester in an amount of 80 to 100%, based on a total weight of the non-aqueous solvent. The electrolyte also contains an electrolyte salt in a concentration of 0.8 to 1.8 mol/kg. The anode active material layer contains a polymer which includes repeating units derived from vinylidene fluoride. A peel strength between the anode active material layer and the negative electrode current collector is 4 mN/mm or more as measured after immersing the anode active material layer into a solvent.

In the above secondary battery, it is preferable that the non-aqueous solvent for the electrolyte prepared by mixing at least one member selected from the group consisting of ethylene carbonate (EC), propylene carbonate (PC), dimethyl carbonate (DMC), ethylmethyl carbonate (EMC), and diethyl carbonate (DEC), wherein the non-aqueous solvent contains either one or both of ethylene carbonate (EC) and propylene carbonate (PC).

It is preferable that the non-aqueous solvent includes propylene carbonate (PC) in an amount of 30 to 80%.

It is preferable that the electrolyte is a gel electrolyte including a vinylidene fluoride component as a matrix polymer in an amount of 70 to 100% by mass.

It is preferable that the solvent is N-methyl-2-pyrrolidone (NMP).

In accordance with another embodiment, there is provided a secondary battery which includes a positive electrode, a negative electrode including an anode active material layer formed on at least one side of an negative electrode current collector, an electrolyte, and a laminate-film casing member containing therein the positive electrode, the negative electrode, and the electrolyte. The electrolyte contains a non-aqueous solvent which includes a cyclic carbonic ester in an amount of 80 to 100%, based on a total weight of the non-aqueous solvent. The electrolyte contains an electrolyte salt in a concentration of 0.8 to 1.8 mol/kg. The anode active material layer contains a polymer which includes repeating units derived from vinylidene fluoride. The anode active material layer during charging has a calorific value of 450 J/g or less at a temperature in the range of from 230 to 370° C., as measured by differential scanning calorimetry(DSC).

It is preferable that the calorific value is 400 J/g or less.

In accordance with a further embodiment, there is provided a secondary battery which includes a positive electrode, a negative electrode including an anode active material layer formed on at least one side of an negative electrode current collector, an electrolyte, and a laminate-film casing member containing therein the positive electrode, the negative electrode, and the electrolyte. The electrolyte contains a non-aqueous solvent which includes a cyclic carbonic ester in an amount of 80 to 100%, based on the total weight of the non-aqueous solvent. The electrolyte contains an electrolyte salt in a concentration of 0.8 to 1.8 mol/kg. The anode active material layer contains a polymer which includes repeating units derived from vinylidene fluoride. The anode active material layer during charging has a difference of 1.60 W/g or less between the maximum calorific value and a calorific value at 100° C., as measured by differential scanning calorimetry.

It is preferable that the difference between the maximum calorific value and a calorific value at 100° C. is 1.40 W/g or less.

In an embodiment, the anode active material layer contains a polymer including vinylidene fluoride, so that the binder contained in the anode active material layer is prevented from swelling under a high temperature environment, making it possible to improve the adhesion between the anode active material layer and the negative electrode current collector.

Additional features and advantages are described herein, and will be apparent from the following Detailed Description and the figures.

### BRIEF DESCRIPTION OF THE FIGURES

FIGS. 1A and 1B are diagrammatic views showing an example of the construction of a secondary battery according to an embodiment.

FIG. 2 is a diagrammatic view showing an example of the construction of a battery element to be contained in a secondary battery according to an embodiment.

FIG. 3 is a diagrammatic view showing an example of the construction of a battery element to be contained in a secondary battery according to an embodiment.

FIG. 4 is a diagrammatic view showing how to measure a tensile strength for a secondary battery according to an embodiment.

FIG. 5 is a cross-sectional view showing an example of the construction of a laminate film used in a secondary battery according to an embodiment.

### DETAILED DESCRIPTION

Hereinbelow, embodiments will be described with reference to the accompanying drawings. A battery using a gel electrolyte is described below, but an electrolyte used in the battery is not limited to the gel electrolyte.

### (1) First Embodiment

(1-1) Construction of Secondary Battery

In the negative electrode used in the secondary battery according to an embodiment, the anode active material layer contains a polymer which includes repeating units derived from vinylidene fluoride (VdF) by, for example, a heat treatment, and then is constructed so that a peel strength between the anode active material layer and negative electrode current collector is 4 mN/mm or more as measured after immersing the anode active material layer into a solvent. The term “a three-dimensional network structure” as used herein means that the polymer has a three-dimensional network structure, i.e., includes a crosslinked structure, and involves a polymer having a crosslinked structure in part of or whole of the polymer.

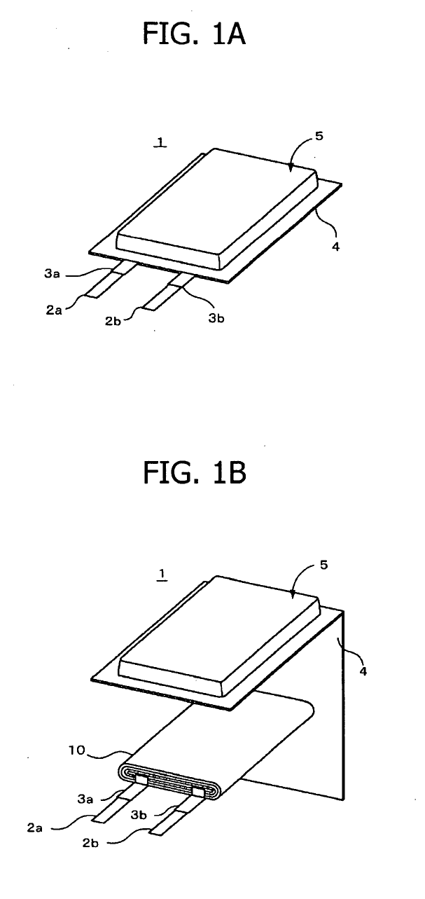

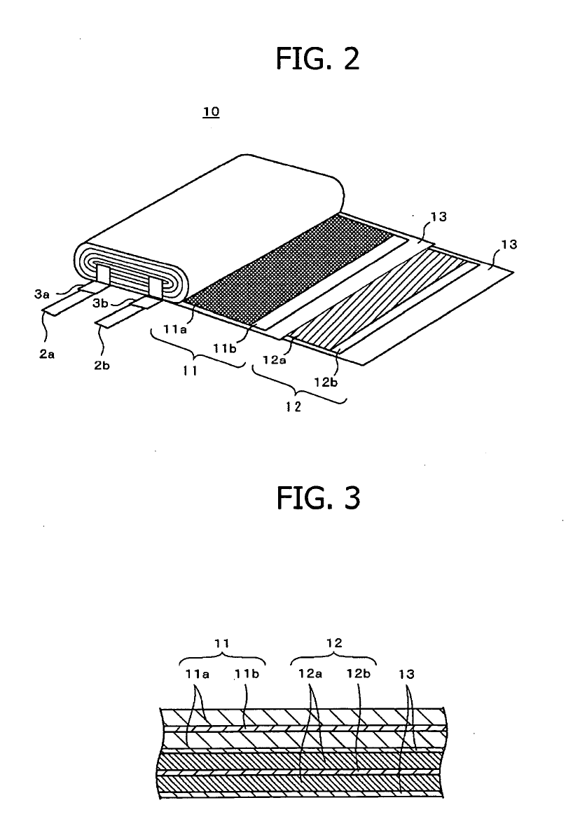

FIG. 1A is a diagrammatic view showing an example of the external appearance of a secondary battery 1 according to an embodiment, and FIG. 1B is a diagrammatic view showing an example of the construction of the secondary battery 1. The secondary battery 1 includes a battery element 10 having a construction shown in FIG. 2 and being covered with a laminate film 4 as a casing member. The battery element 10 includes, as shown in FIG. 3, a strip positive electrode 11 and a strip negative electrode 12 disposed opposite to the positive electrode 11, and a separator, which are stacked alternately and spirally wound together in the longitudinal direction. A gel electrolyte layer (not shown) is formed on both sides of each of the positive electrode 11 and the negative electrode 12. A positive electrode terminal 2a connected to the positive electrode 11 and a negative electrode terminal 2b (hereinafter, frequently referred to as “electrode terminal 2” unless otherwise specified) connected to the negative electrode 12 are electrically extended from the battery element 10.

The battery element 10 is covered with a laminate film 4 which is a casing member. In the laminate film 4 is preliminarily formed a recessed portion 5 by, for example, drawing. The battery element 10 is contained in the recessed portion 5, and the laminate film 4 is disposed so as to cover an opening of the recessed portion 5 and the laminate film around the opening of the recessed portion 5 is sealed up by heat sealing or the like. In this instance, the positive electrode terminal 2a and the negative electrode terminal 2b are electrically extended to the outside from the sealed portions of the laminate film 4. Portions of the positive electrode terminal 2a and the negative electrode terminal 2b in contact with the laminate film 4 are covered, respectively, with bonding films 3a and 3b to improve the bonding of the positive electrode terminal 2a and the negative electrode terminal 2b with the laminate film 4.

Negative Electrode

FIG. 3 shows the construction of the negative electrode 12 in an embodiment. The negative electrode 12 includes, for example, an anode active material layer 12a containing an anode active material and being formed on both sides of a negative electrode current collector 12b having a pair of surfaces opposite to each other. There may be formed a region (not shown) in which the anode active material layer is formed only on one side of the negative electrode current collector.

The negative electrode current collector 12b is required to have an excellent electrochemical stability and an excellent electric conductivity as well as an excellent mechanical strength. The negative electrode 12 is exposed to a highly reductive atmosphere, and metals in the negative electrode including aluminum (Al) are likely to form an alloy, together with lithium (Li), resulting in powdered form. Consequently, the use of a metal material which does not undergo alloying with lithium is needed. Examples of such metal materials include copper (Cu), nickel (Ni), and stainless steel (SUS). Especially, copper (Cu) is preferable because of the high electric conductivity and an excellent flexibility.

The anode active material layer 12a includes, for example, an anode active material, a conductor, and a binder. With respect to the anode active material, metallic lithium, a lithium alloy, a carbon material capable of being doped with lithium and dedoped, or a composite material of a metal material and a carbon material is used. Specific examples of carbon materials capable of being doped with lithium and dedoped include graphite, hardly graphitizable carbon, and easily graphitizable carbon. More specifically, a carbon material, such as pyrolytic carbon, coke (pitch coke, needle coke, or petroleum coke), graphite, glassy carbon, a calcined product of an organic polymer compound (obtained by carbonizing a phenolic resin, a furan resin, or the like by calcination at an appropriate temperature), carbon fiber, or activated carbon, can be used.

Particularly, graphite, such as natural graphite and artificial graphite, is widely used in lithium-ion battery since the graphite has an excellent chemical stability and can undergo a dedoping reaction for lithium ion repeatedly and stably, and further the graphite is easily commercially available.

With respect to the materials other than carbon, various types of metals or semi-metals may be used, and examples include metals or semi-metals capable of forming an alloy together with lithium, such as magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), platinum (Pt), and alloys thereof. These may be either crystalline or amorphous.

With respect to the material capable of being doped with lithium and dedoped, a polymer, such as polyacetylene or polypyrrole, or an oxide, such as SnO₂, may be used.

The anode active material layer 12a contains a binder. With respect to the binder, a polymer including repeating units derived from vinylidene fluoride (VdF) is preferable. Such a polymer has a high stability in the secondary battery. Examples of the polymers include copolymers including polyvinylidene fluoride (PVdF) or vinylidene fluoride (VdF). Specific examples of copolymers include a vinylidene fluoride-hexafluoropropylene (HFP) copolymer, a vinylidene fluoride-tetrafluoroethylene (TFE) copolymer, a vinylidene fluoride-chlorotrifluoroethylene (TFE) copolymer, a vinylidene fluoride-hexafluoropropylene-tetrafluoroethylene copolymer, a vinylidene fluoride-carboxylic acid copolymer, and a vinylidene fluoride-hexafluoropropylene-carboxylic acid copolymer. An example of a vinylidene fluoride-hexafluoropropylene-carboxylic acid copolymer includes a vinylidene fluoride-hexafluoropropylene-monomethyl maleate copolymer. These binders may be used individually or in combination.

The polymer described above is, for example, crosslinked in the anode active material, and therefore the polymer is prevented from swelling, making it possible to improve the adhesion between the anode active material layer 12a and the negative electrode current collector 12b.

A peel strength between the anode active material layer 12a and negative electrode current collector 12b is preferably 4 mN/mm or more, more preferably 5 mN/mm or more, as measured after immersing the negative electrode 12 into a solvent. This is because a satisfactory property can be obtained in case that the negative electrode has the peel strength of this level even after immersing the negative electrode into a solvent.

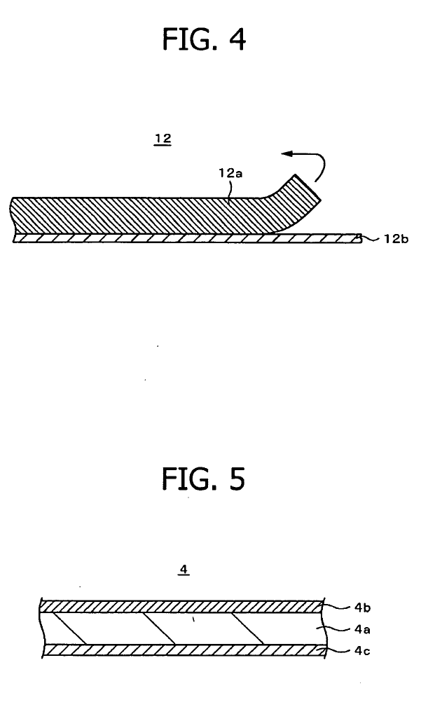

A peel strength after immersing the negative electrode into a solvent can be measured by, for example, the following method. Specifically, the negative electrode 12 immersed into a solvent is heated at 80° C. for one hour, and then is subjected to drying. Then, a peel strength of the anode active material layer 12a is measured by a tensile test in which, for example, as shown in FIG. 4, a tape (not shown) is put on the anode active material layer 12a and the tape is pulled in the direction indicated by an arrow (180° direction). With respect to the tape width, a tape having, for example, a width of 25 mm may be used. A tape peeling test for sample of anode active material can be made by, for example, in accordance with JIS D0202-1988. The tape peeling test is conducted by adhering a cellophane tape (trade name: CT 24, manufactured by Nichiban, Co.) to the anode active material with a ball of a finger by using and then peeling off the cellophane tape. The tensile test can be made by, for example, pulling the tape in a distance of 60 mm in the 180° direction at a rate of 100 mm/min. A value of peel strength is an average of the 10 mm-60 mm measurements and a value specified by the tape width.

With respect to the solvent, N-methyl-2-pyrrolidone (NMP) may be the most effective, but an ester, such as propylene carbonate (PC), ethyl acetate, or butyl acetate, dimethylformamide (DMF), tetrahydrofuran (THF), an amine, such as dimethylamine or triethylamine, or a ketone, such as acetone, may be used.

Positive Electrode

The positive electrode 11 includes a cathode active material layer 11a containing a cathode active material and being formed on both sides of a positive electrode current collector 11b having a pair of surfaces opposite to each other. With respect to the positive electrode current collector 11b, a metallic foil, such as an aluminum (Al) foil, is used.

The cathode active material layer 11a includes, for example, a cathode active material, a conductor, and a binder. With respect to the cathode active material, a composite oxide of lithium and a transition metal, which is composed mainly of Li_{X}MO₂ (wherein M represents at least one transition metal, and X varies depending on the charging/discharging state of the battery, and is generally 0.05 to 1.10), is used. With respect to the transition metal constituting the lithium composite oxide, cobalt (Co), nickel (Ni), manganese (Mn), or the like is used.

Specific examples of the lithium composite oxides include lithium cobaltate (LiCoO₂), lithium nickelate (LiNiO₂), and lithium manganate (LiMn₂O₄). A solid solution obtained by replacing part of the transition metal element in the lithium composite oxide by another element may be used. Examples of the solid solutions include nickel-cobalt composite lithium oxides (e.g., LiNi_{0.5}Co_{0.5}O₂ and LiNi_{0.8}Co_{0.2}O₂). These lithium composite oxides can generate a high voltage and have an excellent energy density. Alternatively, with respect to the cathode active material, a metal sulfide or metal oxide containing no lithium, such as TiS₂, MoS₂, NbSe₂, or V₂O₅, may be used. In the cathode active material, theses materials may be used in combination.

With respect to the conductor, a carbon material, such as carbon black or graphite, is used. With respect to the binder, for example, polyvinylidene fluoride (PVdF) or polytetrafluoroethylene (PTFE), or the like is used.

Laminate Film

The laminate film 4 used as a casing member is composed of a multilayer film having a moisture resistance and insulation properties, which includes, as shown in FIG. 5, an outer resin layer 4b and an inner resin layer 4c formed on respective sides of a metallic foil 4a. In the outer resin layer 4b, for achieving a good external appearance, toughness, flexibility, and the like, nylon (Ny) or polyethylene terephthalate (PET) is used. The metallic foil 4a has a major role in preventing moisture, oxygen, or light from going into the casing member to protect the battery element which is a content, and, from the viewpoint of reduced weight, excellent stretchability, low cost, and excellent processability, aluminum (Al) is most often used. The inner resin layer 4c is a portion to be melted by heat or ultrasonic waves to be heat-sealed, and hence a polyolefin resin material, e.g., cast polypropylene (CPP) is frequently used.

Separator

The separator 13 is composed of, for example, a porous film made of a polyolefin resin material, such as polypropylene (PP) or polyethylene (PE), or a porous film made of an inorganic material, such as ceramic nonwoven fabric, and may be composed of two or more porous films stacked into a laminated structure. Of these, a porous film made of polyethylene (PE) or polypropylene (PP) may be the most effective.

Generally, the usable separator preferably has a thickness of 5 to 50 μm, more preferably 5 to 20 μm. When the separator thickness is too large, the filling ratio of the active material to the separator is reduced to lower the battery capacity, and further the ion conductivity is lowered, so that the current properties become poor. Conversely, when the separator thickness is too small, the film of separator is reduced in mechanical strength, so that foreign matter or the like easily causes short-circuiting between the positive and negative electrodes or breaks the separator.

Electrolyte

In the electrolyte, an electrolyte salt and a non-aqueous solvent generally used in lithium-ion secondary battery may be used. The non-aqueous solvent includes a cyclic carbonic ester, e.g., propylene carbonate (PC) and/or ethylene carbonate (EC), in an amount of 80 to 100%, based on the total weight of the non-aqueous solvent. The non-aqueous solvent may contain, in addition to the cyclic carbonic ester, a chain carbonic ester, for example, at least one member selected from dimethyl carbonate (DMC), ethylmethyl carbonate (EMC), and diethyl carbonate (DEC). When the amount of the cyclic carbonic ester is less than 80%, the amount of a chain carbonic ester having a lower boiling point in the electrolyte is increased and therefore, gas generation is likely to be caused due to decomposition of the electrolyte in the battery, which leads to expansion of the battery. In addition, the electrolyte is lowered in permittivity, so that the electric conductivity is disadvantageously reduced.

With respect to the cyclic carbonic ester, it is preferable that the non-aqueous solvent includes propylene carbonate (PC) in an amount of 30 to 80%, based on the total weight of the non-aqueous solvent. Propylene carbonate (PC) reacts with graphite contained in the negative electrode and decomposes into gas, and therefore it is difficult to solely use propylene carbonate (PC), and propylene carbonate and another solvent are generally used in combination. With respect to the solvent having a low reactivity with graphite, ethylene carbonate (EC) is well known and widely used. Ethylene carbonate (EC) is one of cyclic carbonic esters and has a high boiling point and hence is preferably used.

The amount of propylene carbonate (PC) in the non-aqueous solvent is determined from the relative relationship between propylene carbonate and ethylene carbonate (EC). When the amount of propylene carbonate (PC) is less than 30%, the amount of ethylene carbonate (EC) is more than 70%, but ethylene carbonate (EC) has a melting temperature of 38° C. and, when the non-aqueous solvent containing such a large amount of ethylene carbonate is at a low temperature, the ion conductivity becomes small, thereby lowering the low-temperature properties of the battery. On the other hand, when the amount of propylene carbonate (PC) is more than 80%, the amount of ethylene carbonate (EC) is less than 20%, and the non-aqueous solvent containing such a large amount of propylene carbonate has a high reactivity with graphite, thus causing problems in that the capacity is lowered and that propylene carbonate (PC) decomposes during the first charging of the battery to cause gas generation, which leads to expansion of the battery. Here, the “%” is given by weight.

With respect to the electrolyte salt, an electrolyte salt soluble in the non-aqueous solvent is used, and the salt includes a combination of cation and anion. With respect to the cation, an alkali metal or an alkaline earth metal is used. With respect to the anion, Cl⁻, Br⁻, I⁻, SCN⁻, ClO₄⁻, BF₄⁻, PF₆⁻, CF₃SO₃⁻, or the like is used. Specific examples include lithium hexafluorophosphate (LiPF₆), lithium tetrafluoroborate (LiBF₄), lithium bis(trifluoromethanesulfonyl)imide (LiN(CF₃SO₂)₂), lithium bis(pentafluoroethanesulfonyl)imide (LiN(C₂F₅SO₂)₂), and lithium perchlorate (LiClO₄). With respect to the electrolyte salt concentration, the lithium ion concentration in the non-aqueous solvent is in the range of from 0.8 to 1.8 mol/kg.

When using a gel electrolyte, an electrolytic solution obtained by mixing together the non-aqueous solvent and electrolyte salt is incorporated into a matrix polymer to obtain a gel electrolyte. The matrix polymer is compatible with the non-aqueous solvent. With respect to the matrix polymer, a silicone gel, an acrylic gel, an acrylonitrile gel, a polyphosphazene-modified polymer, polyethylene oxide, polypropylene oxide, or a composite polymer, crosslinked polymer, or modified polymer thereof is used. Examples of fluorine polymers include polymers including repeating units derived from vinylidene fluoride, such as polyvinylidene fluoride (PVdF), a vinylidene fluoride (VdF)-hexafluoropropylene (HFP) copolymer, and a vinylidene fluoride (VdF)-tetrafluoroethylene (TFE) copolymer. These polymers may be used individually or in combination, and the gel electrolyte preferably includes a vinylidene fluoride (VdF) component in an amount of 70 to 100% by mass.

(1-2) Method for Producing a Secondary Battery

The secondary battery 1 having the above-described construction is produced as follows.

Preparation of Positive Electrode

The cathode active material, conductor, and binder are first uniformly mixed to prepare a cathode mixture, and the cathode mixture prepared is dispersed in a solvent to form a slurry. Then, the resultant slurry is uniformly applied to a positive electrode current collector 11b by a doctor blade method or the like, and dried to remove the solvent, followed by compression molding by means of a roll pressing machine or the like, thus forming a cathode active material layer 11a. In this instance, the cathode active material, conductor, binder, and solvent may be mixed in any amounts as long as they are uniformly dispersed.

Then, a positive electrode terminal 2a is connected to one end of the positive electrode current collector 11b by spot welding or ultrasonic welding. The positive electrode terminal 2a is desirably composed of a metallic foil or mesh, but the terminal may be composed of any material other than metals as long as the material is electrochemically and chemically stable and can achieve electrical conduction.

Preparation of Negative Electrode

The anode active material, binder, and optionally a conductor are uniformly mixed to prepare an anode mixture, and the anode mixture prepared is dispersed in a solvent to form a slurry. Then, the resultant slurry is uniformly applied to a negative electrode current collector 12b by a doctor blade method or the like, and dried to remove the solvent, followed by compression molding by means of a roll pressing machine or the like. In this instance, the anode active material, conductor, binder, and solvent may be mixed in any amounts as long as they are uniformly dispersed.

Subsequently, the anode active material layer precursor formed on the negative electrode current collector 12b by compression molding is irradiated with an electron beam, ultraviolet light, or the like, or the anode active material layer precursor is heated to polymerize the binder contained in the anode active material layer precursor, thereby forming an anode active material layer 12a. In this instance, the degree of polymerization of the binder is controlled by appropriately changing conditions, such as the irradiation time and power of an electron beam, ultraviolet light, or the like, or the heating time. Thus, the negative electrode 12 is obtained.

When the anode active material layer precursor is irradiated with an electron beam or ultraviolet light, it is preferable that the irradiation is conducted for 3 minutes or longer. The longer the irradiation time of an electron beam or ultraviolet light, the larger the degree of polymerization of the binder, or the higher the peel strength between the anode active material layer 12a and the negative electrode current collector 12b, i.e., the more excellent the battery properties obtained. When the irradiation time of an electron beam or ultraviolet light is shorter than 3 minutes, there is a possibility that the degree of polymerization of the binder is too low to obtain a satisfactory peel strength.

When the anode active material layer precursor is heated, it is preferable that the heating is conducted at 180° C. or higher. The higher the heating temperature for the anode active material layer precursor, the larger the degree of polymerization of the binder, or the higher the peel strength between the anode active material layer 12a and the negative electrode current collector 12b, i.e., the more excellent the battery properties obtained. When the heating temperature for the anode active material layer precursor is lower than 180° C., there is a possibility that the degree of polymerization of the binder is too low to obtain a satisfactory peel strength.

Then, a negative electrode terminal 2b is connected to one end of the negative electrode current collector 12b by spot welding or ultrasonic welding. The negative electrode terminal 2b is desirably composed of a metallic foil or mesh, but the terminal may be composed of any material other than metals as long as the material is electrochemically and chemically stable and can achieve electrical conduction.

It is preferable that the positive electrode terminal 2a and the negative electrode terminal 2b are electrically extended from the same side, but they may be electrically extended from any sides as long as short-circuiting or the like does not occur and there is no adverse effect on the battery performance. With respect to the joint of the positive electrode terminal 2a and the negative electrode terminal 2b, the joint position and the method for the joint are not limited to the examples mentioned above as long as electrical contact can be made.

Formation of Gel Electrolyte Layer

An electrolyte salt, such as lithium hexafluorophosphate (LiPF₆) or lithium tetrafluoroborate (LiBF₄), is dissolved in a non-aqueous solvent including a cyclic carbonic ester in an amount of 80 to 100% so that the salt concentration becomes 0.8 to 1.8 mol/kg to prepare an electrolytic solution, and then a matrix polymer, such as a vinylidene fluoride (VdF)-hexafluoropropylene (HFP) copolymer, and the electrolytic solution are mixed together to prepare a sol electrolyte.

Subsequently, the sol electrolyte prepared is applied to each of the cathode active material layer 11a and the anode active material layer 12a and cooled to form a gel electrolyte layer. Alternatively, a low-viscosity sol using, e.g., dimethyl carbonate (DMC) as a diluent solvent is prepared, and applied to each of the cathode active material layer 11a and the anode active material layer 12a, and then the diluent solvent is removed by vaporization to form a gel electrolyte layer.

Then, the positive electrode 11, separator 13, negative electrode 12, and separator 13 are stacked successively, and the resultant stacked structure is spirally wound in the longitudinal direction many times. Then, a protective tape is put on the outermost winding layer to prepare a spirally-wound battery element 10.

Then, using a laminate film 4 having a recessed portion 5 formed preliminarily by drawing in the direction of from the inner resin layer 4c to the outer resin layer 4b, the battery element 10 is covered with the laminate film 4 so that, as shown in FIG. 1B, the battery element 10 is contained in the recessed portion 5. In this instance, the battery element is covered with the laminate film so that the inner resin layers 4c of the folded laminate film 4 face each other. Subsequently, the laminate film around the opening of the recessed portion 5 formed in the laminate film 4 is heat-sealed while reducing the internal pressure, thereby producing a secondary battery 1.

The secondary battery 1 may also be produced by the following method. A positive electrode 11 having a positive electrode terminal 2a connected thereto and a negative electrode 12 having a negative electrode terminal 2b connected thereto are first prepared by the above-mentioned method, and a separator 13 is disposed between the positive electrode and the negative electrode and they are stacked on one another and spirally wound together, and a protective tape is put on the outermost winding layer to prepare a battery element 10. In this instance, no gel electrolyte layer is formed. Then, the battery element 10 is covered with a laminate film 4, and the outer edge portion of the laminate film except for one side is heat-sealed so that the laminate film 4 is in a bag form. Subsequently, a composition for electrolyte including a non-aqueous solvent, an electrolyte salt, monomers as a raw material for polymer compound, a polymerization initiator, and optionally other materials, such as a polymerization inhibitor, is prepared, and injected into the laminate film 4 having a bag form.

The composition for electrolyte is injected and then, the opening side of the laminate film 4 is hermetically sealed in a vacuum atmosphere by heat sealing. Then, the laminate film 4 containing the battery element 10 and the composition for electrolyte is heated so that the monomers are polymerized into a polymer compound to form a gel electrolyte, thereby producing a secondary battery 1.

In the secondary battery 1 according to the first embodiment, the anode active material layer 12a contains a polymer which includes repeating units derived from vinylidene fluoride. Accordingly, even when the secondary battery 1 is used under a high temperature environment or the battery is produced under conditions such that the negative electrode 12 is subjected to a high temperature environment, the anode active material layer 12a can be prevented from peeling off and/or flaking off from the negative electrode current collector 12b.

Further, the anode active material layer 12a can be prevented from peeling off and/or flaking off from the negative electrode current collector 12b without increasing the amount of the binder in the anode active material layer, so that a secondary battery having an excellent battery property without lowering the battery capacity can be obtained.

### (2) Second Embodiment

(2-1) Construction of Secondary Battery

The construction of the secondary battery according to the second embodiment is the same as the construction of the secondary battery according to the first embodiment, except for negative electrode, and the descriptions of the same construction are omitted. The constituents of the negative electrode in the second embodiment are the same as those of the negative electrode in the first embodiment and therefore, in the first and second embodiments, like parts or portions are indicated by like reference numerals.

Negative Electrode

As in the case of the negative electrode in the first embodiment, the negative electrode 12 used in the secondary battery according to the second embodiment includes an anode active material layer 12a containing an anode active material and being formed on both sides of an negative electrode current collector 12b having a pair of surfaces opposite to each other. The anode active material layer 12a includes, for example, an anode active material, a conductor, and a binder. With respect to the anode active material, metallic lithium, a lithium alloy, a carbon material capable of being doped with lithium and dedoped, or a composite material of a metal material and a carbon material is used. With respect to the materials for the anode active material, conductor, and binder, the same materials as those in the first embodiment may be used.

In the negative electrode 12 in the second embodiment, the anode active material layer 12a is subjected to heat treatment to reduce the amount of fluorine contained in the anode active material layer, wherein the fluorine and lithium occluded in the anode active material undergo an exothermic reaction to cause a rise in the battery temperature. The heat treatment is conducted at a temperature equal to or higher than the melting temperature of the binder contained in the anode active material layer 12a. In this case, a rise in the battery temperature due to an exothermic reaction between lithium occluded in the anode active material or the like and fluorine contained in the binder is suppressed.

Specifically, the anode active material layer 12a which occludes lithium or the like, i.e., the anode active material layer 12a during charging has a total calorific value of 450 J/g or less, preferably 400 J/g or less, as measured by differential scanning calorimetry (DSC) at a temperature in the range of from 230 to 370° C. in which a reaction peak of lithium and fluorine is present. Alternatively, the anode active material layer 12a during charging has a difference of 1.60 W/g or less, preferably 1.40 W/g or less, between the maximum calorific value at a temperature in the range of from 230 to 370° C., in which a reaction peak of lithium and fluorine is present, and a calorific value at 100° C., as measured by differential scanning calorimetry. This is because when the calorific value is in the above range, the adhesion of the anode active material layer 12a to the negative electrode current collector 12b can be improved, thereby effectively suppressing the exothermic reaction.

(2-2) Method for Producing a Secondary Battery

The secondary battery 1 having the above-described construction is produced as follows. Only a method for producing the negative electrode 12 is described below.

Preparation of Negative Electrode

The anode active material, binder, and optionally a conductor are uniformly mixed to prepare an anode mixture, and the anode mixture prepared is dispersed in a solvent to form a slurry. Then, the resultant slurry is uniformly applied to the negative electrode current collector 12b, and dried to remove the solvent, followed by compression molding by means of a roll pressing machine or the like.

Subsequently, the anode active material layer precursor formed on the negative electrode current collector 12b by compression molding is heated to reduce the amount of fluorine contained in the anode active material layer precursor, thereby forming an anode active material layer 12a.

The anode active material layer precursor is heated at the melting temperature of the binder or higher. When polyvinylidene fluoride is used as the binder, the melting temperature of the binder is about 130 to 170° C. The higher the heating temperature for the anode active material layer precursor, the larger the amount of the fluorine reduced, or the more unlikely the exothermic reaction between lithium occluded in the anode active material and fluorine contained in the anode active material layer 12a occurs. When the heating temperature for the anode active material layer precursor is lower than 150° C., there is a possibility that the reduction of fluorine in the binder is too small to suppress an exothermic reaction between lithium occluded in the anode active material and fluorine contained in the anode active material layer 12a.

Then, a negative electrode terminal 2b is connected to one end of the negative electrode current collector 12b by spot welding or ultrasonic welding. The negative electrode terminal 2b is desirably composed of a metallic foil or mesh, but the terminal may be composed of any material other than metals as long as the material is electrochemically and chemically stable and can achieve electrical conduction.

In the secondary battery 1 according to the second embodiment, the anode active material layer during charging has a calorific value of 450 J/g or less at a temperature in the range of from 230 to 370° C. in which a reaction peak of lithium and fluorine is present, or the anode active material layer during charging has a difference of 1.60 W/g or less between the maximum calorific value and a calorific value at 100° C., and therefore the amount of fluorine contained in the anode active material layer 12a is reduced to suppress an exothermic reaction between fluorine and lithium occluded in the anode active material. Accordingly, decomposition of the binder can be suppressed even upon vigorous heat generation of the battery. Consequently, the anode active material layer 12a can be prevented from peeling off and/or flaking off from the negative electrode current collector 12b without increasing the amount of the binder. Thus, a secondary battery having excellent battery properties and a high safety while maintaining the battery capacity can be obtained.

### EXAMPLES

Hereinbelow, the present application will be described in more detail with reference to the following Examples, which should not be construed as limiting the scope of the present application.

### Example 1

(1) Method for Treatment of Negative Electrode: Electron Beam Irradiation

Sample 1

Preparation of Positive Electrode

Lithium carbonate (Li₂CO₃) and cobalt carbonate (CoCO₃) were mixed in a 0.5:1 molar ratio, and calcined in air at 900° C. for 5 hours to obtain lithium cobaltate (LiCoO₂). Subsequently, lithium cobaltate (LiCoO₂) as a cathode active material, graphite as a conductor, and polyvinylidene fluoride (PVdF) as a binder were intimately mixed in a 91:6:3 mass ratio, and the resultant mixture was dispersed in N-methyl-2-pyrrolidone to prepare a cathode mixture slurry. The cathode mixture slurry prepared was uniformly applied to both sides of a positive electrode current collector composed of an aluminum (Al) foil having a thickness of 20 μm, and subjected to vacuum drying in an atmosphere at 120° C. for 12 hours to form a cathode active material layer. Then, the cathode active material layer was subjected to pressure molding by means of a roll pressing machine to form a positive electrode sheet, and the resultant positive electrode sheet was cut into a strip positive electrode.

Then, a positive electrode terminal composed of an aluminum (Al) ribbon was welded to a portion on the positive electrode current collector in which the cathode active material layer was not formed. A bonding film composed of acid-modified polypropylene was formed on the aluminum (Al) ribbon at a portion facing a laminate film which covered the battery element later.

Preparation of Negative Electrode

Using as an anode active material mesophase graphite fine spheres having an average particle size of 20 μm, and using as a binder a copolymer including vinylidene fluoride and monomethyl maleate copolymerized in a 99:1 mass ratio and having a number average molecular weight of 800,000, the anode active material and binder were uniformly mixed in a 95:5 mass ratio, and the resultant mixture was dispersed in N-methyl-2-pyrrolidone to prepare an anode mixture slurry. Then, the anode mixture slurry prepared was uniformly applied to both sides of an negative electrode current collector composed of a copper (Cu) foil having a thickness of 15 μm so that the thickness of each slurry applied became 50 μm, and subjected to vacuum drying in an atmosphere at 120° C. for 10 minutes to form an anode active material layer. Then, the anode active material layer was subjected to pressure molding by means of a roll pressing machine to form a negative electrode sheet, and the resultant negative electrode sheet was cut into a strip negative electrode.

Subsequently, the anode active material layer was not irradiated with an electron beam and the binder contained in the anode active material layer was not polymerized (crosslinked), thereby forming a negative electrode. Then, a negative electrode terminal composed of a nickel (Ni) ribbon was welded to a portion on the negative electrode current collector in which the anode active material layer was not formed. A bonding film composed of acid-modified polypropylene was formed on the nickel (Ni) ribbon at a portion facing a laminate film which covered the battery element later.

Formation of Gel Electrolyte Layer

Using as a non-aqueous solvent a mixed solvent obtained by mixing together ethylene carbonate (EC) and propylene carbonate (PC) in a 4:6 mass ratio, lithium hexafluorophosphate (LiPF₆) as an electrolyte salt was dissolved in the mixed solvent so that the molar concentration became 0.3 mol/kg to prepare a non-aqueous electrolytic solution. Using as a matrix polymer a copolymer including vinylidene fluoride (VdF) and hexafluoropropylene (HFP) copolymerized in a 93:7 mass ratio and having a number average molecular weight of 700,000, and using dimethyl carbonate (DMC) as a diluent solvent, the matrix polymer, non-aqueous electrolytic solution, and diluent solvent were mixed in a 1:10:10 mass ratio and dissolved at 70° C. to obtain a sol electrolyte.

Then, the above-obtained sol electrolyte was applied to both sides of each of the positive electrode and the negative electrode, and the diluent solvent was removed by volatilization using warm air at 100° C. to form a gel electrolyte layer having a thickness of 20 μm on the surfaces of each of the positive electrode and the negative electrode. Subsequently, a separator composed of a porous polyethylene film having a thickness of 20 μm was disposed between the positive electrode and the negative electrode each having a gel electrolyte layer formed thereon, and they were stacked on one another and spirally wound together to prepare a battery element.

The battery element prepared was covered with an aluminum laminate film, and the laminate film was sealed to form a secondary battery. The aluminum laminate film had a structure including a nylon (Ny) film having a thickness of 30 μm and a crystalline polypropylene (PP) film having a thickness of 30 μm formed on the respective surfaces of an aluminum (Al) foil having a thickness of 40 μm, and the laminate film was disposed so that the crystalline polypropylene film corresponded to the inner side (battery element side). The battery element was contained in a recessed portion preliminarily formed in the aluminum laminate film, and the aluminum laminate film was folded back to cover the opening of the recessed portion, and then three sides of the outer edge portion of the laminate film except for the folded back one side were heat-sealed for vacuum seal. The positive electrode terminal and the negative electrode terminal were electrically extended outside from the sealed portions of the aluminum laminate film. Portions of the positive electrode terminal and the negative electrode terminal facing the aluminum laminate film were highly hermetically sealed by using bonding films.

Sample 2

A secondary battery was prepared in the same manner as in sample 1, except that the anode active material layer precursor was irradiated with an electron beam for 3 minutes to polymerize (crosslink) the binder contained in the anode active material layer.

Sample 3

A secondary battery was prepared in the same manner as in sample 1, except that the anode active material layer precursor was irradiated with an electron beam for 10 minutes to polymerize (crosslink) the binder contained in the anode active material layer.

Sample 4

A secondary battery was prepared in the same manner as in sample 1, except that the anode active material layer precursor was irradiated with an electron beam for 30 minutes to polymerize (crosslink) the binder contained in the anode active material layer.

Sample 5

A secondary battery was prepared in the same manner as in sample 1, except that lithium hexafluorophosphate (LiPF₆) as an electrolyte salt was dissolved in the mixed solvent so that the molar concentration became 0.8 mol/kg.

Sample 6

A secondary battery was prepared in the same manner as in sample 1, except that lithium hexafluorophosphate (LiPF₆) as an electrolyte salt was dissolved in the mixed solvent so that the molar concentration became 0.8 mol/kg, and that the anode active material layer precursor was irradiated with an electron beam for 3 minutes.

Sample 7

A secondary battery was prepared in the same manner as in sample 1, except that lithium hexafluorophosphate (LiPF₆) as an electrolyte salt was dissolved in the mixed solvent so that the molar concentration became 0.8 mol/kg, and that the anode active material layer precursor was irradiated with an electron beam for 10 minutes.

Sample 8

A secondary battery was prepared in the same manner as in sample 1, except that lithium hexafluorophosphate (LiPF₆) as an electrolyte salt was dissolved in the mixed solvent so that the molar concentration became 0.8 mol/kg, and that the anode active material layer precursor was irradiated with an electron beam for 30 minutes.

Sample 9

A secondary battery was prepared in the same manner as in sample 1, except that lithium hexafluorophosphate (LiPF₆) as an electrolyte salt was dissolved in the mixed solvent so that the molar concentration became 1.2 mol/kg.

Sample 10

A secondary battery was prepared in the same manner as in sample 1, except that lithium hexafluorophosphate (LiPF₆) as an electrolyte salt was dissolved in the mixed solvent so that the molar concentration became 1.2 mol/kg, and that the anode active material layer precursor was irradiated with an electron beam for 3 minutes.

Sample 11

A secondary battery was prepared in the same manner as in sample 1, except that lithium hexafluorophosphate (LiPF₆) as an electrolyte salt was dissolved in the mixed solvent so that the molar concentration became 1.2 mol/kg, and that the anode active material layer precursor was irradiated with an electron beam for 10 minutes.

Sample 12

A secondary battery was prepared in the same manner as in sample 1, except that lithium hexafluorophosphate (LiPF₆) as an electrolyte salt was dissolved in the mixed solvent so that the molar concentration became 1.2 mol/kg, and that the anode active material layer precursor was irradiated with an electron beam for 30 minutes.

Sample 13

A secondary battery was prepared in the same manner as in sample 1, except that lithium hexafluorophosphate (LiPF₆) as an electrolyte salt was dissolved in the mixed solvent so that the molar concentration became 1.8 mol/kg.

Sample 14

A secondary battery was prepared in the same manner as in sample 1, except that lithium hexafluorophosphate (LiPF₆) as an electrolyte salt was dissolved in the mixed solvent so that the molar concentration became 1.8 mol/kg, and that the anode active material layer precursor was irradiated with an electron beam for 3 minutes.

Sample 15

A secondary battery was prepared in the same manner as in sample 1, except that lithium hexafluorophosphate (LiPF₆) as an electrolyte salt was dissolved in the mixed solvent so that the molar concentration became 1.8 mol/kg, and that the anode active material layer precursor was irradiated with an electron beam for 10 minutes.

Sample 16

A secondary battery was prepared in the same manner as in sample 1, except that lithium hexafluorophosphate (LiPF₆) as an electrolyte salt was dissolved in the mixed solvent so that the molar concentration became 1.8 mol/kg, and that the anode active material layer precursor was irradiated with an electron beam for 30 minutes.

Sample 17

A secondary battery was prepared in the same manner as in sample 1, except that lithium hexafluorophosphate (LiPF₆) as an electrolyte salt was dissolved in the mixed solvent so that the molar concentration became 1.9 mol/kg.

Sample 18

A secondary battery was prepared in the same manner as in sample 1, except that lithium hexafluorophosphate (LiPF₆) as an electrolyte salt was dissolved in the mixed solvent so that the molar concentration became 1.9 mol/kg, and that the anode active material layer precursor was irradiated with an electron beam for 3 minutes.

Sample 19

A secondary battery was prepared in the same manner as in sample 1, except that lithium hexafluorophosphate (LiPF₆) as an electrolyte salt was dissolved in the mixed solvent so that the molar concentration became 1.9 mol/kg, and that the anode active material layer precursor was irradiated with an electron beam for 10 minutes.

Sample 20

A secondary battery was prepared in the same manner as in sample 1, except that lithium hexafluorophosphate (LiPF₆) as an electrolyte salt was dissolved in the mixed solvent so that the molar concentration became 1.9 mol/kg, and that the anode active material layer precursor was irradiated with an electron beam for 30 minutes.

(2) Method for Treatment of Negative Electrode: Heating in Vacuum

Sample 21

A secondary battery was prepared in the same manner as in sample 1, except that the strip negative electrode sheet obtained by subjecting the anode active material layer to pressure molding by means of a roll pressing machine was heated in a vacuum at a heating temperature of 25° C. for 12 hours. In the heating time of 12 hours, a period of 4 hours from the start of heating corresponds to a temperature elevation time.

Sample 22

A secondary battery was prepared in the same manner as in sample 21, except that the heating temperature was changed to 180° C.

Sample 23

A secondary battery was prepared in the same manner as in sample 21, except that the heating temperature was changed to 200° C.

Sample 24

A secondary battery was prepared in the same manner as in sample 21, except that the heating temperature was changed to 220° C.

Sample 25

A secondary battery was prepared in the same manner as in sample 21, except that lithium hexafluorophosphate (LiPF₆) as an electrolyte salt was dissolved in the mixed solvent so that the molar concentration became 0.8 mol/kg.

Sample 26

A secondary battery was prepared in the same manner as in sample 21, except that lithium hexafluorophosphate (LiPF₆) as an electrolyte salt was dissolved in the mixed solvent so that the molar concentration became 0.8 mol/kg, and that the heating temperature was changed to 180° C.

Sample 27

A secondary battery was prepared in the same manner as in sample 21, except that lithium hexafluorophosphate (LiPF₆) as an electrolyte salt was dissolved in the mixed solvent so that the molar concentration became 0.8 mol/kg, and that the heating temperature was changed to 200° C.

Sample 28

A secondary battery was prepared in the same manner as in sample 21, except that lithium hexafluorophosphate (LiPF₆) as an electrolyte salt was dissolved in the mixed solvent so that the molar concentration became 0.8 mol/kg, and that the heating temperature was changed to 220° C.

Sample 29

A secondary battery was prepared in the same manner as in sample 21, except that lithium hexafluorophosphate (LiPF₆) as an electrolyte salt was dissolved in the mixed solvent so that the molar concentration became 1.2 mol/kg.

Sample 30

A secondary battery was prepared in the same manner as in sample 21, except that lithium hexafluorophosphate (LiPF₆) as an electrolyte salt was dissolved in the mixed solvent so that the molar concentration became 1.2 mol/kg, and that the heating temperature was changed to 180° C.

Sample 31

A secondary battery was prepared in the same manner as in sample 21, except that lithium hexafluorophosphate (LiPF₆) as an electrolyte salt was dissolved in the mixed solvent so that the molar concentration became 1.2 mol/kg, and that the heating temperature was changed to 200° C.

Sample 32

A secondary battery was prepared in the same manner as in sample 21, except that lithium hexafluorophosphate (LiPF₆) as an electrolyte salt was dissolved in the mixed solvent so that the molar concentration became 1.2 mol/kg, and that the heating temperature was changed to 220° C.

Sample 33

A secondary battery was prepared in the same manner as in sample 21, except that lithium hexafluorophosphate (LiPF₆) as an electrolyte salt was dissolved in the mixed solvent so that the molar concentration became 1.8 mol/kg.

Sample 34

A secondary battery was prepared in the same manner as in sample 21, except that lithium hexafluorophosphate (LiPF₆) as an electrolyte salt was dissolved in the mixed solvent so that the molar concentration became 1.8 mol/kg, and that the heating temperature was changed to 180° C.

Sample 35

A secondary battery was prepared in the same manner as in sample 21, except that lithium hexafluorophosphate (LiPF₆) as an electrolyte salt was dissolved in the mixed solvent so that the molar concentration became 1.8 mol/kg, and that the heating temperature was changed to 200° C.

Sample 36

A secondary battery was prepared in the same manner as in sample 21, except that lithium hexafluorophosphate (LiPF₆) as an electrolyte salt was dissolved in the mixed solvent so that the molar concentration became 1.8 mol/kg, and that the heating temperature was changed to 220° C.

Sample 37

A secondary battery was prepared in the same manner as in sample 21, except that lithium hexafluorophosphate (LiPF₆) as an electrolyte salt was dissolved in the mixed solvent so that the molar concentration became 1.9 mol/kg.

Sample 38

A secondary battery was prepared in the same manner as in sample 21, except that lithium hexafluorophosphate (LiPF₆) as an electrolyte salt was dissolved in the mixed solvent so that the molar concentration became 1.9 mol/kg, and that the heating temperature was changed to 180° C.

Sample 39

A secondary battery was prepared in the same manner as in sample 21, except that lithium hexafluorophosphate (LiPF₆) as an electrolyte salt was dissolved in the mixed solvent so that the molar concentration became 1.9 mol/kg, and that the heating temperature was changed to 200° C.

Sample 40

A secondary battery was prepared in the same manner as in sample 21, except that lithium hexafluorophosphate (LiPF₆) as an electrolyte salt was dissolved in the mixed solvent so that the molar concentration became 1.9 mol/kg, and that the heating temperature was changed to 220° C.

Evaluations of Properties

(a) High-Temperature Cycle Test

With respect to each of the secondary batteries of samples 1 to 40, a constant-current charging was conducted at a constant current of 1 C in an environment at 60° C. until the battery voltage became 4.2 V, and then a constant-voltage charging was conducted at a constant voltage of 4.2 V until the charging time became 2.5 hours in total. Then, a constant-current discharging was conducted at a constant current of 1 C until the battery voltage became 3.0 V, and a discharge capacity in the first cycle was measured.

Subsequently, 400 cycles of the charging and discharging operations were conducted under the same conditions, and then a discharge capacity in the 400th cycle was measured, and a capacity maintaining ratio of the discharge capacity in the 400th cycle to the discharge capacity in the first cycle was determined by making a calculation.

A sample having a capacity retention ratio of 70% or more was judged to be excellent.

(b) High-Temperature Storage Test

With respect to each of the secondary batteries of samples 1 to 40, a constant-current charging was conducted at a constant current of 1 C until the battery voltage became 4.2 V, and then a constant-voltage charging was conducted at a constant voltage of 4.2 V until the charging time became 2.5 hours in total. Further, the resultant secondary battery was stored in an environment at 80° C. for 14 days, and then a constant-current discharging was conducted at a constant current of 0.2 C until the battery voltage became 3.0 V, and a residual capacity was measured. The discharge capacity in the first cycle measured in the cycle test of item (a) above was used as a capacity before storage, and a retention ratio of the residual capacity to the capacity before storage was determined by making a calculation.

With respect to the resultant battery, the charging and discharging operations were conducted again under the same conditions, and a recovered capacity was measured. The discharge capacity in the first cycle measured in the cycle test of item (a) above was used as a capacity before storage, and a recovery ratio of the recovered capacity to the capacity before storage was determined by making a calculation.

With respect to the residual capacity, a sample having a retention ratio of 65% or more was judged to be excellent, and, with respect to the recovered capacity, a sample having a recovery ratio of 85% or more was judged to be excellent.

(c) Dissolution Peel Test

With respect to each of the secondary batteries of samples 1 to 40, a constant-current charging was conducted at a constant current of 1 C until the battery voltage became 4.2 V, and then a constant-voltage charging was conducted at a constant voltage of 4.2 V until the charging time became 2.5 hours in total. Next, each secondary battery was disassembled, and the negative electrode was taken out and washed with dimethyl carbonate (DMC). Then, the negative electrode was impregnated with N-methyl-2-pyrrolidone (NMP) in an environment at 80° C. for one hour and then dried, and, with respect to the resultant negative electrode, a peel strength between the negative electrode current collector and the anode active material layer was measured.

A peel strength was measured by a method in which a tape was put on the anode active material layer and the tape was pulled in the direction indicated by an arrow shown in FIG. 4 (180° direction). The tape had a width of 25 mm, and the tape was pulled in a distance of 60 mm in the 180° direction at a rate of 100 mm/min. A value of peel strength was an average of the 10 mm-60 mm measurements and a value specified by the tape width.

The results of evaluations with respect to the secondary batteries of samples 1 to 20 are shown in Table 1 below. The results of evaluations with respect to the secondary batteries of samples 21 to 40 are shown in Table 2 below. In the tables below, a sample in which the anode active material layer is not flaked off from the negative electrode current collector is rated “o”, and a sample in which the anode active material layer is flaked off from the negative electrode current collector is rated “x”.

TABLE 1

| | | | Cycle test | | Storage | | |
|---|---|---|---|---|---|---|---|
| | | | capacity | Storage test | test | | Negative |
| | Salt | Irradiation | retention | retention | recovery | Disassembling | electrode |
| | concentration | time | ratio | ratio | ratio | and | peel test |
| | (mol/kg) | (min) | (%) | (%) | (%) | observation | (mN/mm) |
| Sample 1 | 0.3 | 0 | 48 | 41 | 61 | ∘ | 6.7 |
| Sample 2 | 0.3 | 3 | 45 | 39 | 58 | ∘ | 8.6 |
| Sample 3 | 0.3 | 10 | 47 | 38 | 55 | ∘ | 17.4 |
| Sample 4 | 0.3 | 30 | 39 | 42 | 60 | ∘ | 31.1 |
| Sample 5 | 0.8 | 0 | 65 | 57 | 77 | ∘ | 3.3 |
| Sample 6 | 0.8 | 3 | 72 | 61 | 85 | ∘ | 8.1 |
| Sample 7 | 0.8 | 10 | 83 | 66 | 93 | ∘ | 15.3 |
| Sample 8 | 0.8 | 30 | 84 | 66 | 93 | ∘ | 27.7 |
| Sample 9 | 1.2 | 0 | 52 | 51 | 72 | x | — |
| Sample 10 | 1.2 | 3 | 73 | 62 | 86 | ∘ | 7.7 |
| Sample 11 | 1.2 | 10 | 78 | 68 | 89 | ∘ | 13.3 |
| Sample 12 | 1.2 | 30 | 82 | 71 | 93 | ∘ | 22.5 |
| Sample 13 | 1.8 | 0 | 47 | 43 | 67 | x | — |
| Sample 14 | 1.8 | 3 | 78 | 61 | 86 | ∘ | 6.5 |
| Sample 15 | 1.8 | 10 | 78 | 64 | 87 | ∘ | 10.3 |
| Sample 16 | 1.8 | 30 | 73 | 69 | 89 | ∘ | 16.8 |
| Sample 17 | 1.9 | 0 | 21 | 35 | 44 | x | — |
| Sample 18 | 1.9 | 3 | 35 | 39 | 53 | x | — |
| Sample 19 | 1.9 | 10 | 52 | 47 | 60 | x | — |
| Sample 20 | 1.9 | 30 | 65 | 51 | 61 | ∘ | 5.3 |

∘: Anode active material layer is not flaked off from negative electrode current collector.
x: Anode active material layer is flaked off from negative electrode current collector.

TABLE 2

| | | | Cycle test | | Storage | | |
|---|---|---|---|---|---|---|---|
| | | | capacity | Storage test | test | | Negative |
| | Salt | Heating | retention | retention | recovery | Disassembling | electrode |
| | concentration | temperature | ratio | ratio | ratio | and | peel test |
| | (mol/kg) | (° C.) | (%) | (%) | (%) | observation | (mN/mm) |
| Sample 21 | 0.3 | 25 | 48 | 41 | 61 | ∘ | 6.7 |
| Sample 22 | 0.3 | 180 | 44 | 37 | 58 | ∘ | 17.5 |
| Sample 23 | 0.3 | 200 | 46 | 39 | 55 | ∘ | 20.3 |
| Sample 24 | 0.3 | 220 | 38 | 43 | 60 | ∘ | 21.1 |
| Sample 25 | 0.8 | 25 | 65 | 57 | 77 | ∘ | 3.3 |
| Sample 26 | 0.8 | 180 | 84 | 70 | 91 | ∘ | 18.7 |
| Sample 27 | 0.8 | 200 | 85 | 69 | 93 | ∘ | 17.7 |
| Sample 28 | 0.8 | 220 | 86 | 72 | 94 | ∘ | 19.4 |
| Sample 29 | 1.2 | 25 | 52 | 51 | 72 | x | — |
| Sample 30 | 1.2 | 180 | 81 | 69 | 91 | ∘ | 12.5 |
| Sample 31 | 1.2 | 200 | 83 | 71 | 94 | ∘ | 13.3 |
| Sample 32 | 1.2 | 220 | 84 | 73 | 93 | ∘ | 14.0 |
| Sample 33 | 1.8 | 25 | 47 | 43 | 67 | x | — |
| Sample 34 | 1.8 | 180 | 77 | 73 | 86 | ∘ | 6.5 |
| Sample 35 | 1.8 | 200 | 79 | 71 | 87 | ∘ | 7.7 |
| Sample 36 | 1.8 | 220 | 79 | 74 | 89 | ∘ | 8.3 |
| Sample 37 | 1.9 | 25 | 19 | 35 | 44 | x | — |
| Sample 38 | 1.9 | 180 | 45 | 41 | 59 | x | — |
| Sample 39 | 1.9 | 200 | 49 | 45 | 60 | x | — |
| Sample 40 | 1.9 | 220 | 44 | 53 | 61 | ∘ | 5.2 |

∘: Anode active material layer is not flaked off from negative electrode current collector.
x: Anode active material layer is flaked off from negative electrode current collector.

As can be seen from Table 1, with respect to the sample having an electrolyte salt concentration of the electrolyte of 0.8 mol/kg, sample 5 in which the irradiation time of electron beam is 0 minute suffers no removal of the anode active material layer, but it has a low peel strength between the negative electrode current collector and the anode active material layer. With respect to the samples having the same electrolyte salt concentration (0.8 mol/kg), the secondary batteries of samples 6 to 8 in which the binder is polymerized (crosslinked) by irradiation with an electron beam are improved in all the capacity retention ratio, storage test retention ratio, storage test recovery ratio, and peel strength, as compared to sample 5 in which no electron beam irradiation is conducted. The longer the irradiation time of electron beam, the higher the peel strength, or the more excellent the battery properties.

With respect to the samples having an electrolyte salt concentration of the electrolyte of 1.2 mol/kg or 1.8 mol/kg, similarly, the secondary battery in which the binder is polymerized (crosslinked) by irradiation with an electron beam is improved in battery properties, as compared to the secondary battery in which no electron beam irradiation is conducted. The longer the irradiation time of electron beam, the more excellent the properties of the secondary battery.

In contrast, with respect to samples 1 to 4 each having an electrolyte salt concentration of the electrolyte of 0.3 mol/kg, the electrolyte salt concentration is low so that neither peeling nor flaking of the anode active material layer occurs, irrespective of the irradiation time of electron beam. However, the low electrolyte salt concentration does not satisfactorily cause a battery reaction, so that the battery properties become poor.

With respect to samples 17 to 20 each having an electrolyte salt concentration of the electrolyte of 1.9 mol/kg, the electrolyte salt concentration is high so that the adhesion between the negative electrode current collector and the anode active material layer is poor or the anode active material is peeled off or is flaked off from the current collector, irrespective of the irradiation time of electron beam, whereby the battery properties become poor.

As can be seen from Table 2, with respect to the sample having an electrolyte salt concentration of the electrolyte of 0.8 mol/kg, sample 25 in which the heating temperature is 25° C. suffers no removal of the anode active material layer, but it has a low peel strength between the negative electrode current collector and the anode active material layer. With respect to the samples having the same electrolyte salt concentration, the secondary batteries of samples 26 to 28 in which the heating temperature is 180 to 220° C. and the binder is polymerized (crosslinked) are improved in all the capacity retention ratio, storage test retention ratio, storage test recovery ratio, and peel strength, as compared to sample 25. The higher the heating temperature, the higher the peel strength, or the more excellent the battery properties.

Samples 29 and 33 individually have an electrolyte salt concentration higher than that of sample 25, and suffer removal of the anode active material layer. However, samples 30 to 32 and samples 34 to 36, in which the heating temperature is 180° C. or higher, are improved in peel strength and excellent in all the capacity retention ratio, storage test retention ratio, storage test recovery ratio, and peel strength.

As in the case of samples 1 to 4, samples 21 to 24 individually have a low electrolyte salt concentration such that no flaking off of the negative electrode occurs, but a battery reaction does not proceed satisfactorily and hence the battery properties become poor. As in the case of samples 17 to 20, samples 37 to 40 individually have a high electrolyte salt concentration such that the anode active material layer is flaked off from the current collector even when the binder contained in the anode active material layer is polymerized (crosslinked), so that the battery properties become poor.

From the above results of evaluations, it has been found that, with respect to the secondary battery having an electrolyte salt concentration of 0.8 to 1.8 mol/kg, when the binder contained in the anode active material layer is polymerized (crosslinked) by a method of irradiation with an electron beam or heating in a vacuum to achieve a peel strength of 4 mN/mm or more, excellent capacity retention ratio and excellent storage test retention ratio as well as excellent storage test recovery ratio can be obtained.

### Example 2

In Example 2, the anode active material layer is heated to control the amount of fluorine contained in the anode active material layer, thereby evaluating the battery performance. The amount of fluorine contained in the anode active material layer is indicated by a calorific value of the anode active material layer during charging at a temperature in the range of from 230 to 370° C. in which a reaction peak of lithium and fluorine is present, as measured by differential scanning calorimetry, and by a difference between the maximum calorific value and a calorific value at 100° C.

Sample 41

Preparation of Positive Electrode

A positive electrode was prepared in the same manner as in sample 1, except that lithium cobaltate (LiCoO₂) as a cathode active material, graphite as a conductor, and polyvinylidene fluoride (PVdF) as a binder were mixed in a 91:6:10 mass ratio.

Preparation of Negative Electrode

Pulverized graphite powder as an anode active material and polyvinylidene fluoride as a binder were uniformly mixed in a 90:10 mass ratio, and the resultant mixture was dispersed in N-methyl-2-pyrrolidone to prepare an anode mixture slurry. Then, the anode mixture slurry prepared was uniformly applied to both sides of an negative electrode current collector composed of a copper (Cu) foil having a thickness of 15 μm so that the thickness of each slurry applied became 50 μm, and subjected to vacuum drying in an atmosphere at 120° C. for 10 minutes to form an anode active material layer. Then, the anode active material layer was subjected to pressure molding by means of a roll pressing machine, and further subjected to heat treatment at 80° C. to form a negative electrode sheet, and the resultant negative electrode sheet was cut into a strip negative electrode. The heat treatment was conducted by exposing the electrode to an atmosphere of argon (Ar) gas in an oven at a predetermined temperature for 8 hours.

Subsequently, a negative electrode terminal composed of a nickel (Ni) ribbon was welded to a portion on the negative electrode current collector in which the anode active material layer was not formed. An adhesion film composed of acid-modified polypropylene was provided on the nickel (Ni) ribbon at a portion facing a laminate film which covered the battery element later.

Formation of Gel Electrolyte Layer

Using as a non-aqueous solvent a mixed solvent obtained by mixing together ethylene carbonate (EC) and propylene carbonate (PC) in a 1:1 mass ratio, lithium hexafluorophosphate (LiPF₆) as an electrolyte salt was dissolved in the mixed solvent so that the molar concentration became 0.3 mol/kg to prepare a non-aqueous electrolytic solution. Using as a matrix polymer a copolymer including vinylidene fluoride (VdF) and hexafluoropropylene (HFP) copolymerized in a mass ratio 93:7 and having a number average molecular weight of 700,000, and using dimethyl carbonate (DMC) as a diluent solvent, the matrix polymer, non-aqueous electrolytic solution, and diluent solvent were mixed in a 1:10:10 mass ratio and dissolved at 70° C. to obtain a sol electrolyte.

Then, the above-obtained sol electrolyte was applied to both sides of each of the positive electrode and the negative electrode, and the diluent solvent was removed by volatilization using warm air at 100° C. to form a gel electrolyte layer having a thickness of 20 μm on the surfaces of each of the positive electrode and the negative electrode. Subsequently, a separator composed of a porous polyethylene film having a thickness of 20 μm was disposed between the positive electrode and the negative electrode each having a gel electrolyte layer formed thereon, and they were stacked on one another and spirally wound together to prepare a battery element.

The battery element prepared was covered with an aluminum laminate film and the laminate film was sealed to form a secondary battery. With respect to the aluminum laminate film, the same aluminum laminate film as that used in sample 1 was used.

With respect to the resultant secondary battery, the anode active material layer during charging had a calorific value of 550 J/g at a temperature in the range of from 230 to 370° C., as measured by differential scanning calorimetry. Further, the anode active material layer during charging had a difference of 1.80 W/g between the maximum calorific value and a calorific value at 100° C., as measured by differential scanning calorimetry.

The calorific value and the difference between the maximum calorific value and a calorific value at 100° C. (hereinafter, frequently referred to as “calorific value difference”) were measured by the following method. The secondary battery was first charged until the battery voltage became 4.20 V, and then the resultant battery was disassembled, and the negative electrode was taken out and washed with dimethyl carbonate (DMC). Then, a sample of 4 mg was taken from the anode active material layer in the negative electrode, and subjected to differential scanning calorimetry to measure a calorific value at 230 to 370° C. and a calorific value difference. In the differential scanning calorimetry, differential scanning calorimeter DSC 220U, manufactured and sold by Seiko Instruments Inc., was used, alumina (Al₂O₃) was used as a reference substance for measurement, and the scanning rate was 10° C./minute.

Sample 42

A secondary battery was prepared in the same manner as in sample 41, except that the heating treatment temperature for the negative electrode was changed to 150° C. In this secondary battery, the anode active material layer had a calorific value of 450 J/g, as measured by differential scanning calorimetry, and the calorific value difference was 1.60 W/g.

Sample 43

A secondary battery was prepared in the same manner as in sample 41, except that the heat treatment temperature for the negative electrode was changed to 200° C. In this secondary battery, the anode active material layer had a calorific value of 400 J/g, as measured by differential scanning calorimetry, and the calorific value difference was 1.40 W/g.

Sample 44

A secondary battery was prepared in the same manner as in sample 41, except that the heat treatment temperature for the negative electrode was changed to 220° C. In this secondary battery, the anode active material layer had a calorific value of 300 J/g, as measured by differential scanning calorimetry, and the calorific value difference was 1.30 W/g.

Sample 45

A secondary battery was prepared in the same manner as in sample 41, except that the lithium hexafluorophosphate (LiPF₆) molar concentration of the non-aqueous electrolytic solution was changed to 0.8 mol/kg.

Sample 46

A secondary battery was prepared in the same manner as in sample 41, except that the lithium hexafluorophosphate (LiPF₆) molar concentration of the non-aqueous electrolytic solution was changed to 0.8 mol/kg, and that the heating treatment temperature for the negative electrode was changed to 150° C. In this secondary battery, the anode active material layer had a calorific value of 450 J/g, as measured by differential scanning calorimetry, and the calorific value difference was 1.60 W/g.

Sample 47

A secondary battery was prepared in the same manner as in sample 41, except that the lithium hexafluorophosphate (LiPF₆) molar concentration of the non-aqueous electrolytic solution was changed to 0.8 mol/kg, and that the heating treatment temperature for the negative electrode was changed to 200° C. In this secondary battery, the anode active material layer had a calorific value of 400 J/g, as measured by differential scanning calorimetry, and the calorific value difference was 1.40 W/g.

Sample 48

A secondary battery was prepared in the same manner as in sample 41, except that the lithium hexafluorophosphate (LiPF₆) molar concentration of the non-aqueous electrolytic solution was changed to 0.8 mol/kg, and that the heating treatment temperature for the negative electrode was changed to 220° C. In this secondary battery, the anode active material layer had a calorific value of 300 J/g, as measured by differential scanning calorimetry, and the calorific value difference was 1.30 W/g.

Sample 49

A secondary battery was prepared in the same manner as in sample 41, except that the lithium hexafluorophosphate (LiPF₆) molar concentration of the non-aqueous electrolytic solution was changed to 1.2 mol/kg.

Sample 50

A secondary battery was prepared in the same manner as in sample 41, except that the lithium hexafluorophosphate (LiPF₆) molar concentration of the non-aqueous electrolytic solution was changed to 1.2 mol/kg, and that the heating treatment temperature for the negative electrode was changed to 150° C. In this secondary battery, the anode active material layer had a calorific value of 450 J/g, as measured by differential scanning calorimetry, and the calorific value difference was 1.60 W/g.

Sample 51

A secondary battery was prepared in the same manner as in sample 41, except that the lithium hexafluorophosphate (LiPF₆) molar concentration of the non-aqueous electrolytic solution was changed to 1.2 mol/kg, and that the heating treatment temperature for the negative electrode was changed to 200° C. In this secondary battery, the anode active material layer had a calorific value of 400 J/g, as measured by differential scanning calorimetry, and the calorific value difference was 1.40 W/g.

Sample 52

A secondary battery was prepared in the same manner as in sample 41, except that the lithium hexafluorophosphate (LiPF₆) molar concentration of the non-aqueous electrolytic solution was changed to 1.2 mol/kg, and that the heating treatment temperature for the negative electrode was changed to 220° C. In this secondary battery, the anode active material layer had a calorific value of 300 J/g, as measured by differential scanning calorimetry, and the calorific value difference was 1.30 W/g.

Sample 53

A secondary battery was prepared in the same manner as in sample 41, except that the lithium hexafluorophosphate (LiPF₆) molar concentration of the non-aqueous electrolytic solution was changed to 1.8 mol/kg.

Sample 54

A secondary battery was prepared in the same manner as in sample 41, except that the lithium hexafluorophosphate (LiPF₆) molar concentration of the non-aqueous electrolytic solution was changed to 1.8 mol/kg, and that the heating treatment temperature for the negative electrode was changed to 150° C. In this secondary battery, the anode active material layer had a calorific value of 450 J/g, as measured by differential scanning calorimetry, and the calorific value difference was 1.60 W/g.

Sample 55

A secondary battery was prepared in the same manner as in sample 41, except that the lithium hexafluorophosphate (LiPF₆) molar concentration of the non-aqueous electrolytic solution was changed to 1.8 mol/kg, and that the heating treatment temperature for the negative electrode was changed to 200° C. In this secondary battery, the anode active material layer had a calorific value of 400 J/g, as measured by differential scanning calorimetry, and the calorific value difference was 1.40 W/g.

Sample 56

A secondary battery was prepared in the same manner as in sample 41, except that the lithium hexafluorophosphate (LiPF₆) molar concentration of the non-aqueous electrolytic solution was changed to 1.8 mol/kg, and that the heating treatment temperature for the negative electrode was changed to 220° C. In this secondary battery, the anode active material layer had a calorific value of 300 J/g, as measured by differential scanning calorimetry, and the calorific value difference was 1.30 W/g.

Sample 57

A secondary battery was prepared in the same manner as in sample 41, except that the lithium hexafluorophosphate (LiPF₆) molar concentration of the non-aqueous electrolytic solution was changed to 1.9 mol/kg.

Sample 58

A secondary battery was prepared in the same manner as in sample 41, except that the lithium hexafluorophosphate (LiPF₆) molar concentration of the non-aqueous electrolytic solution was changed to 1.9 mol/kg, and that the heating treatment temperature for the negative electrode was changed to 150° C. In this secondary battery, the anode active material layer had a calorific value of 450 J/g, as measured by differential scanning calorimetry, and the calorific value difference was 1.60 W/g.

Sample 59

A secondary battery was prepared in the same manner as in sample 41, except that the lithium hexafluorophosphate (LiPF₆) molar concentration of the non-aqueous electrolytic solution was changed to 1.9 mol/kg, and that the heating treatment temperature for the negative electrode was changed to 200° C. In this secondary battery, the anode active material layer had a calorific value of 400 J/g, as measured by differential scanning calorimetry, and the calorific value difference was 1.40 W/g.

Sample 60

A secondary battery was prepared in the same manner as in sample 41, except that the lithium hexafluorophosphate (LiPF₆) molar concentration of the non-aqueous electrolytic solution was changed to 1.9 mol/kg, and that the heating treatment temperature for the negative electrode was changed to 220° C. In this secondary battery, the anode active material layer had a calorific value of 300 J/g, as measured by differential scanning calorimetry, and the calorific value difference was 1.30 W/g.

Evaluations of Properties

(a) High-Temperature Storage Test

With respect to each of the secondary batteries of samples 41 to 60, a constant-current charging was conducted at a constant current of 1 C until the battery voltage became 4.2 V, and then a constant-voltage charging was conducted at a constant voltage of 4.2 V until the charging time became 2.5 hours in total. Then, a constant-current discharging was conducted at a constant current of 1 C until the battery voltage became 3.0 V, and a discharge capacity was measured and used as a capacity before storage.

Separately, with respect to each of the secondary batteries of samples 41 to 60, a constant-current charging operation was conducted at a constant current of 1 C until the battery voltage became 4.2 V, and then a constant-voltage charging was conducted at a constant voltage of 4.2 V until the charging time became 2.5 hours in total. Further, the resultant secondary battery was stored in an environment at 60° C. for 14 days, and then a constant-current discharging was conducted at a constant current of 0.2 C until the battery voltage became 3.0 V, and a residual capacity was measured, and a retention ratio of the residual capacity to the capacity before storage was determined by making a calculation.

Further, with respect the resultant battery, the charging and discharging operations were conducted again under the same conditions, and a recovered capacity was measured, and a recovery ratio of the recovered capacity to the capacity before storage was determined by making a calculation.

With respect to the residual capacity, a sample having a retention ratio of 65% or more was judged to be excellent, and, with respect to the recovered capacity, a sample having a recovery ratio of 85% or more was judged to be excellent.

(b) Disassembling and Observation

With respect to each of the secondary batteries of samples 41 to 60 obtained after the storage test, the battery was disassembled and the appearance of the anode active material layer was observed.

(c) Nail Penetration Test

With respect to each of the secondary batteries of samples 41 to 60, a constant-current charging was conducted at a constant current of 1 C until the battery voltage became 4.35 V, and then the resultant battery was penetrated with a nail having a diameter of 2.5 mm in the thicknesswise direction of the battery and the highest temperature of the battery was measured.

The results of evaluations with respect to the secondary batteries of samples 41 to 60 are shown in Table 3 below. In the table below, a sample in which the anode active material layer is not flaked off from the negative electrode current collector is rated “o”, and a sample in which the peel strength between the negative electrode current collector and the anode active material layer is such low that the anode active material layer is flaked off from the negative electrode current collector is rated “x”. A sample which suffered abnormal heat generation of the battery in the nail penetration test to eject gas is designated by “Gas ejection”. The battery form which gas ejected had the highest temperature of the battery of 300° C. or higher.

TABLE 3

| | | | | | | | | Highest |
|---|---|---|---|---|---|---|---|---|
| | | | Calorific | | Storage | Storage | | temperature |
| | | | value at | Calorific | test | test | | in nail |
| | Salt | Heating | 230 to | value | retention | recovery | Disassembling | penetration |
| | concentration | temperature | 370° C. | difference | ratio | ratio | and | test |
| | (mol/kg) | (° C.) | (J/g) | (W/g) | (%) | (%) | observation | (° C.) |
| Sample 41 | 0.3 | 80 | 550 | 1.80 | 41 | 61 | ∘ | 90 |
| Sample 42 | 0.3 | 150 | 450 | 1.60 | 37 | 58 | ∘ | 85 |
| Sample 43 | 0.3 | 200 | 400 | 1.40 | 39 | 55 | ∘ | 77 |
| Sample 44 | 0.3 | 220 | 300 | 1.30 | 43 | 60 | ∘ | 65 |
| Sample 45 | 0.8 | 80 | 550 | 1.80 | 57 | 77 | x | Gas |
| | | | | | | | | ejection |
| Sample 46 | 0.8 | 150 | 450 | 1.60 | 70 | 91 | ∘ | 110 |
| Sample 47 | 0.8 | 200 | 400 | 1.40 | 69 | 93 | ∘ | 82 |
| Sample 48 | 0.8 | 220 | 300 | 1.30 | 72 | 94 | ∘ | 71 |
| Sample 49 | 1.2 | 80 | 550 | 1.80 | 51 | 72 | x | Gas |
| | | | | | | | | ejection |
| Sample 50 | 1.2 | 150 | 450 | 1.60 | 69 | 91 | ∘ | 107 |
| Sample 51 | 1.2 | 200 | 400 | 1.40 | 71 | 94 | ∘ | 79 |
| Sample 52 | 1.2 | 220 | 300 | 1.30 | 73 | 93 | ∘ | 72 |
| Sample 53 | 1.8 | 80 | 550 | 1.80 | 43 | 67 | x | Gas |
| | | | | | | | | ejection |
| Sample 54 | 1.8 | 150 | 450 | 1.60 | 73 | 86 | ∘ | 104 |
| Sample 55 | 1.8 | 200 | 400 | 1.40 | 71 | 87 | ∘ | 74 |
| Sample 56 | 1.8 | 220 | 300 | 1.30 | 74 | 89 | ∘ | 66 |
| Sample 57 | 1.9 | 80 | 550 | 1.80 | 35 | 44 | x | Gas |
| | | | | | | | | ejection |
| Sample 58 | 1.9 | 150 | 450 | 1.60 | 41 | 59 | x | Gas |
| | | | | | | | | ejection |
| Sample 59 | 1.9 | 200 | 400 | 1.40 | 45 | 60 | x | 110 |
| Sample 60 | 1.9 | 220 | 300 | 1.30 | 53 | 61 | ∘ | 68 |

∘: Anode active material layer is not flaked off from negative electrode current collector.
x: Anode active material layer is flaked off from negative electrode current collector.

As can be seen from Table 3, with respect to the sample having an electrolyte salt concentration of the electrolyte of 0.8 mol/kg, sample 45 in which the heating temperature is 80° C. suffered flaked-off of the anode active material layer. In addition, in the nail penetration test, the battery caused abnormal heat generation to eject gas. With respect to the sample having the same electrolyte salt concentration (0.8 mol/kg), the secondary batteries of samples 46 to 48, in which the heating temperature for the negative electrode is the melting temperature of the binder or higher, i.e., 150° C. or higher and the amount of fluorine in the anode active material layer is reduced, are improved in all the storage test retention ratio, storage test recovery ratio, and peel strength, as compared to sample 45. The higher the heating temperature for the negative electrode, the more excellent the battery properties, or the lower the highest temperature in the nail penetration test.

With respect to samples 49 to 56 having an electrolyte salt concentration of the electrolyte of 1.2 mol/kg or 1.8 mol/kg, similarly, the secondary battery, in which the heating temperature for the negative electrode is the melting temperature of the binder or higher, i.e., 150° C. or higher and the amount of fluorine in the anode active material layer is reduced, is improved in battery properties, as compared to the secondary batteries of samples 49 and 53 in which the heating temperature is lower. The higher the heating temperature, the more excellent the battery properties. Further, the gas ejection in the nail penetration test can be suppressed. The higher the heating temperature, the lower the highest temperature of the battery.

In contrast, with respect to samples 41 to 44 each having an electrolyte salt concentration of the electrolyte of 0.3 mol/kg, the electrolyte salt concentration is low so that neither peeling nor flaking-off of the anode active material layer occurs, irrespective of the heating temperature for the negative electrode. However, the low electrolyte salt concentration does not satisfactorily cause a battery reaction, so that the battery properties become very poor.

With respect to samples 57 to 60 each having an electrolyte salt concentration of the electrolyte of 1.9 mol/kg, the electrolyte salt concentration is high such that the anode active material is peeled off or is flaked off from the current collector even when the heating temperature for the negative electrode is 200° C., whereby the battery properties become poor. Further, the high electrolyte salt concentration disadvantageously lowers the adhesion between the anode active material layer and the negative electrode current collector, thereby lowering the storage test retention ratio and storage test recovery ratio.

From the above results of evaluations, it has been found that, with respect to the secondary battery having an electrolyte salt concentration of 0.8 to 1.8 mol/kg, when the negative electrode is heated to the melting temperature of the binder contained in the anode active material layer or higher, a rise in the battery temperature can be suppressed without lowering the storage test retention ratio and storage test recovery ratio.

Specifically, it has been found that, when the anode active material layer during charging has a calorific value of 450 J/g or less at a temperature in the range of from 230 to 370° C., as measured by differential scanning calorimetry, or has a difference of 1.60 W/g or less between the maximum calorific value and a calorific value at 100° C., both excellent battery properties and high safety can be achieved.

Further, it has been found that, when the anode active material layer during charging has a calorific value of 400 J/g or less at a temperature in the range of from 230 to 370° C., as measured by differential scanning calorimetry, or has a difference of 1.40 W/g or less between the maximum calorific value and a calorific value at 100° C., the highest temperature in the nail penetration test can be reduced to lower than 100° C., thus further improving the safety.

Hereinabove, embodiments are described in detail, but the present application is not limited to the above embodiments, and can be changed or modified based on the technical concept thereof.

For example, the values or numbers mentioned in the above embodiments are merely examples, and values or numbers different from them can be used if desired.

The negative electrode and electrolyte in the secondary battery of embodiments can be applied to not only a battery using a laminate film in the casing but also a battery using a battery can in the casing.

The secondary battery according to an embodiment is advantageous in that, even when the battery is used or produced under a high temperature environment, the anode active material layer is prevented from peeling off and/or flaking off from the negative electrode current collector, thus maintaining excellent battery properties including a high battery capacity and excellent cycle characteristics.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a positive electrode;
a negative electrode including an anode active material layer formed on at least one side of a negative electrode current collector;
an electrolyte; and
a laminate-film casing member containing therein the positive electrode, the negative electrode, and the electrolyte,
wherein the electrolyte contains a non-aqueous solvent which includes a cyclic carbonic ester in an amount of 80 to 100%, based on a total weight of the non-aqueous solvent,
the electrolyte contains an electrolyte salt in a concentration of 0.8 to 1.8 mol/kg,
the anode active material layer contains a polymer which includes repeating units derived from vinylidene fluoride, and
a peel strength between the anode active material layer and negative electrode current collector is 4 mN/mm or more as measured after immersing the anode active material layer into a solvent.

2. The secondary battery according to claim 1, wherein the non-aqueous solvent for the electrolyte is prepared by mixing at least one selected from the group consisting of ethylene carbonate, propylene carbonate, dimethyl carbonate, ethylmethyl carbonate, and diethyl carbonate, the non-aqueous solvent containing either one or both of ethylene carbonate and propylene carbonate.

3. The secondary battery according to claim 2, wherein the non-aqueous solvent includes propylene carbonate in an amount of 30 to 80%.

4. The secondary battery according to claim 1, wherein the electrolyte is a gel electrolyte including a vinylidene fluoride component as a matrix polymer in an amount of 70 to 100% by mass.

5. The secondary battery according to claim 1, wherein the solvent is N-methyl-2-pyrrolidone.

6. The secondary battery according to claim 1, wherein the electrolyte is prepared by mixing an electrolyte solution and a matrix polymer of vinylidene fluoride-hexafluoropropylene copolymer, the electrolyte solution including an electrolyte salt of lithium hexafluorophosphate or lithium tetrafluoroborate, dissolved in a non-aqueous solvent including a cyclic carbonic ester in an amount of 80 to 100% to have a concentration of the electrolyte salt in a range of 0.8 to 1.8 mol/kg.

7. A secondary battery comprising:
a positive electrode;
a negative electrode including an anode active material layer formed on at least one side of an negative electrode current collector;
an electrolyte; and
a laminate-film casing member containing therein the positive electrode, negative electrode, and electrolyte,
wherein the electrolyte containing a non-aqueous solvent which includes a cyclic carbonic ester in an amount of 80 to 100%, based on a total weight of the non-aqueous solvent,
the electrolyte containing an electrolyte salt in a concentration of 0.8 to 1.8 mol/kg,
the anode active material layer containing a polymer which includes repeating units derived from vinylidene fluoride, and
the anode active material layer during charging has a calorific value of 450 J/g or less at a temperature in a range of from 230 to 370° C., as measured by differential scanning calorimetry.

8. The secondary battery according to claim 7, wherein the calorific value is 400 J/g or less.

9. The secondary battery according to claim 7, wherein the non-aqueous solvent for the electrolyte is prepared by mixing at least one selected from the group consisting of ethylene carbonate, propylene carbonate, dimethyl carbonate, ethylmethyl carbonate, and diethyl carbonate, the non-aqueous solvent containing either one or both of ethylene carbonate and propylene carbonate.

10. The secondary battery according to claim 9, wherein the non-aqueous solvent includes propylene carbonate in an amount of 30 to 80%.

11. The secondary battery according to claim 7, wherein the electrolyte is a gel electrolyte including a vinylidene fluoride component as a matrix polymer in an amount of 70 to 100% by mass.

12. A secondary battery comprising:
a positive electrode;
a negative electrode including an anode active material layer formed on at least one side of an negative electrode current collector;
an electrolyte; and
a laminate-film casing member containing therein the positive electrode, the negative electrode, and the electrolyte,
wherein the electrolyte containing a non-aqueous solvent which includes a cyclic carbonic ester in an amount of 80 to 100%, based on a total weight of the non-aqueous solvent,
the electrolyte containing an electrolyte salt in a concentration of 0.8 to 1.8 mol/kg,
the anode active material layer containing a polymer which includes repeating units derived from vinylidene fluoride, and
the anode active material layer during charging has a difference of 1.60 W/g or less between the maximum calorific value and a calorific value at 100° C., as measured by differential scanning calorimetry.

13. The secondary battery according to claim 12, wherein a difference between the maximum calorific value and a calorific value at 100° C. is 1.40 W/g or less.
